(19) United States
(12) Patent Application Publication
(10) Pub. No.: US 2014/0116032 A1
(43) Pub. Date: May 1, 2014

(54) Injector with Capillary Aerosol Generator

(71) Applicant: TENNECO AUTOMOTIVE OPERATING COMPANY INC., Lake Forest, IL (US)

(72) Inventors: Dervis Argun Yetkin, Ann Arbor, MI (US); Adam J. Kotrba, Laingsburg, MI (US); Gabriel Salanta, Ann Arbor, MI (US); Stephen M. Thomas, Laingsburg, MI (US)

(73) Assignee: TENNECO AUTOMOTIVE OPERATING COMPANY INC., Lake Forest, IL (US)

(21) Appl. No.: 13/664,775

(22) Filed: Oct. 31, 2012

(51) Int. Cl. F01N 3/36; F02M 51/06; F02M 61/18; B05B 1/24

(52) U.S. Cl. 60/295; 239/135; 239/533.12; 239/136; 239/585.1

(57) ABSTRACT

An injector for injecting a reagent includes an axially translatable valve member positioned within a housing. An electromagnet is positioned within the housing and includes a coil of wire positioned proximate the valve member such that the valve member moves between a seated position and an unseated position relative to an orifice in response to energizing the electromagnet. A capillary tube is provided to convert liquid reagent to an ambient pressure vapor and supply it to the orifice.

### FIELD

The present disclosure relates to injector systems and, more particularly, relates to an injector system for injecting a reagent, such as liquid diesel fuel or, an aqueous urea solution into an exhaust stream to reduce oxides of nitrogen (NOₓ) emissions from diesel engine exhaust.

### BACKGROUND

This section provides background information related to the present disclosure which is not necessarily prior art. Lean burn engines provide improved fuel efficiency by operating with an excess of oxygen; that is, a quantity of oxygen that is greater than the amount necessary for complete combustion of the available fuel. Such engines are said to run “lean” or on a “lean mixture.” However, this improved or increase in fuel economy, as opposed to non-lean burn combustion, is offset by undesired pollution emissions, specifically in the form of oxides of nitrogen (NOₓ).

One method used to reduce NOₓ emissions from lean burn internal combustion engines is known as selective catalytic reduction (SCR). SCR, when used, for example, to reduce NOₓ emissions from a diesel engine, involves injecting an atomized reagent into the exhaust stream of the engine in relation to one or more selected engine operational parameters, such as exhaust gas temperature, engine rpm or engine load as measured by engine fuel flow, turbo boost pressure or exhaust NOₓ mass flow. The reagent/exhaust gas mixture is passed through a reactor containing a catalyst, such as, for example, activated carbon, or metals such as platinum, vanadium or tungsten, which are capable of reducing the NOₓ concentration in the presence of the reagent.

An aqueous urea solution is known to be an effective reagent in SCR systems for diesel engines. However, use of such an aqueous urea solution involves many disadvantages. Urea is highly corrosive and may adversely affect mechanical components of the SCR system, such as the injectors used to inject the urea mixture into the exhaust gas stream. Urea also may solidify upon prolonged exposure to high temperatures, such as temperatures encountered in diesel exhaust systems. Solidified urea will accumulate in the narrow passageways and exit orifice openings typically found in injectors. Solidified urea may also cause fouling of moving parts of the injector and clog any openings or urea flow passageways, thereby rendering the injector unusable.

Some reagent injection systems are configured to include a pump, a supply line and a return line such that aqueous urea is continuously pumped to minimize solidification and also transfer heat from the injector to the aqueous urea stored at a remote location. Typically, an injector is equipped with an inlet coupled to the supply line and a spaced apart outlet coupled to the return line. While injectors configured in this manner have functioned sufficiently in the past, packaging and cost concerns may arise regarding the provision and applying of more than one reagent flow line. Other considerations include ease of installation, reagent flow uniformity and a possible benefit regarding moving the reagent inlet further away from the heat source. Accordingly, it may be desirable to provide an improved system including an injector for injecting a liquid fuel or urea into the exhaust. It may be advantageous to vaporize the liquid fuel. As such, an injector including an integrated capillary aerosol generator may be provided.

### SUMMARY

This section provides a general summary of the disclosure, and is not a comprehensive disclosure of its full scope or all of its features.

An injector having a valve nozzle for injecting a liquid hydrocarbon into an exhaust system is disclosed. The injector includes an axially translatable valve member positioned within a housing. An electromagnet is positioned within the housing and includes a coil of wire positioned proximate the valve member such that the valve member moves between a seated position and an unseated position relative to an orifice in response to energizing the electromagnet. An inlet tube is adapted to receive pressurized liquid hydrocarbon from a source of liquid hydrocarbon. A capillary tube is disposed between the inlet tube and the valve nozzle to selectively provide atomized liquid hydrocarbon into the nozzle.

An injector for injecting a reagent into an exhaust system is disclosed. The injector includes an axially translatable valve member positioned within a housing. An electromagnet is positioned within the housing such that the valve member moves between a seated position and an unseated position relative to an orifice in response to energizing the electromagnet. An inlet tube is adapted to receive pressurized reagent from a source of reagent and supply it to a capillary feed tube. The capillary feed tube is adapted to supply heated reagent to an injection nozzle. An inner body is positioned within the housing to at least partially define a flow path for reagent to pass between the inner body and the housing. Reagent flows from the inlet tube, through the flow path and a bypass passage to the return tube when the valve member is in the seated position to cool the injector. A portion of the reagent flows from the inlet tube, through the capillary feed tube, and out of the orifice when the valve member is in the unseated position.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic depicting an exemplary exhaust treatment system including an electromagnetically controlled reagent injector constructed in accordance with the teachings of the present disclosure;

FIG. 2 is a perspective view of the reagent injector;

FIG. 3 is a cross-sectional view taken through the injector depicted in FIG. 2;

FIG. 4 is an exploded perspective view of the reagent injector shown in FIGS. 2 and 3; and

FIG. 5 is an enlarged cross-sectional view of the injector shown in FIGS. 2-4.

Corresponding reference numerals indicate corresponding parts throughout the several views of the drawings.

### DETAILED DESCRIPTION

Example embodiments will now be described more fully with reference to the accompanying drawings.

It should be understood that although the present teachings may be described in connection with diesel engines and the reduction of NOₓ emissions, the present teachings may be used in connection with any one of a number of exhaust streams such as, by way of non-limiting example, those from diesel, gasoline, turbine, fuel cell, jet or any other power source outputting a discharge stream. Moreover, the present teachings may be used in connection with the reduction of any one of a number of undesired emissions. For example, injection of hydrocarbons for the regeneration of diesel particulate filters is also within the scope of the present disclosure. For additional description, attention should be directed to commonly-assigned U.S. Pat. No. 8,047,452, issued Nov. 1, 2011, entitled “Method and Apparatus for Injecting Atomized Fluids,” which is incorporated herein by reference.

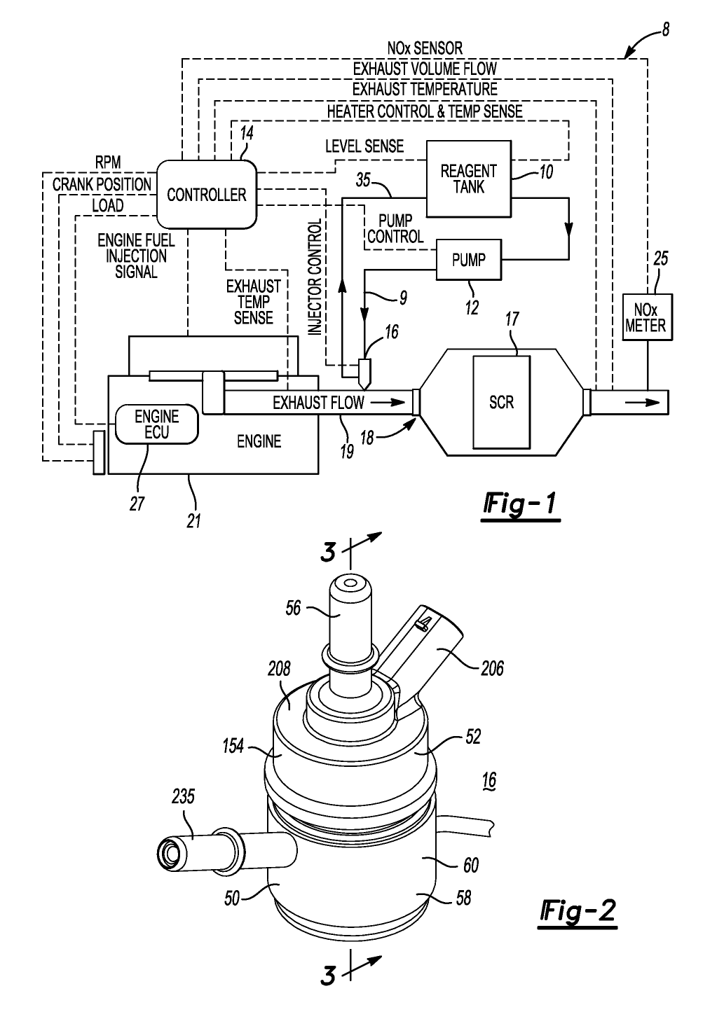

With reference to the figures, a pollution control system 8 for reducing NOₓ emissions from the exhaust of an internal combustion engine 21 is provided. In FIG. 1, solid lines between the elements of the system denote fluid lines for reagent and dashed lines denote electrical connections. The system of the present teachings may include a fuel or reagent tank 10 for holding the reagent and a delivery module 12 for delivering the reagent from the tank 10. The reagent may be a hydrocarbon such as for example diesel fuel, an alkyl ester, alcohol, an organic compound, or a water urea solution. Additionally, the reagent can be a blend or combination of reagents.

Optionally, partially oxidized hydrocarbon molecules (diesel or ethanol) can act as a reductant when used together with the SCR to remove NOx. Additionally, a urea solution can be used as a reductant to react with and remove NOx components from the exhaust gas. It should also be appreciated that one or more reagents may be available in the system and may be used singly or in combination. The tank 10 and delivery module 12 may form an integrated reagent tank/delivery module. Also provided as part of system 8 is an electronic injection controller 14, a reagent injector 16, and an exhaust system 18. Exhaust system 18 includes an exhaust conduit 19 providing an exhaust stream to at least one catalyst bed 17. In instances when the reagent is a diesel fuel or other hydrocarbon such as ethanol, injection of the reagent after the engine into the exhaust flow causes the oxidation of the hydrocarbon and forms an exotherm. This exotherm can function to burn off collected soot from the diesel particulate filter. Additionally, the exotherm can function, at low exhaust temperature levels, to heat up the catalyst bed 17 or components such as the Diesel Oxidation Catalyst (DOC), Selective Catalytic Reactor (SCR), Lean NOx Catalyst (LNC), or the Lean NOx Trap (LNT).

The delivery module 12 may comprise a pump that supplies reagent or fuel from the tank 10 via a supply line 9. The tank 10 may be polypropylene, epoxy coated carbon steel, PVC, or stainless steel and sized according to the application (e.g., vehicle size, intended use of the vehicle, and the like). A pressure regulator (not shown) may be provided to maintain the system at predetermined pressure setpoint (e.g., relatively low pressures of approximately 60-80 psi, or in some embodiments a pressure of approximately 60-150 psi) and may be located in the return line 35 from the reagent injector 16. A pressure sensor may be provided in the supply line 9 leading to the reagent injector 16.

The system may also incorporate various freeze protection strategies to thaw frozen reagent or to prevent the reagent from freezing. During system operation, regardless of whether or not the injector is releasing reagent into the exhaust gases, reagent may be circulated continuously between the tank 10 and the reagent injector 16 to cool the injector and minimize the dwell time of the reagent in the injector so that the reagent remains cool. Continuous reagent circulation may be necessary for temperature-sensitive reagents, such as aqueous urea, which tend to solidify upon exposure to elevated temperatures of 300° C. to 650° C. as would be experienced in an engine exhaust system.

Furthermore, it may be desirable to keep the reagent mixture below 140° C. and preferably in a lower operating range between 5° C. and 95° C. to ensure that solidification of the reagent is prevented. Solidified reagent, if allowed to form, may foul the moving parts, associated capillary feed tubes and openings of the injector.

The amount of reagent required may vary with load, exhaust gas temperature, exhaust gas flow, engine fuel injection timing, desired NOₓ reduction, barometric pressure, relative humidity, EGR rate and engine coolant temperature. A NOₓ sensor or meter 25 is positioned downstream from catalyst bed 17. NOₓ sensor 25 is operable to output a signal indicative of the exhaust NOₓ content to an engine control unit 27. All or some of the engine operating parameters may be supplied from engine control unit 27 via the engine/vehicle data bus to the reagent electronic injection controller 14. The reagent electronic injection controller 14 could also be included as part of the engine control unit 27. Exhaust gas temperature, exhaust gas flow and exhaust back pressure and other vehicle operating parameters may be measured by respective sensors. The injection controller 14 provides an injector control which, as described below, functions to control the actuation of the pintle 156 and capillary tube heater 256.

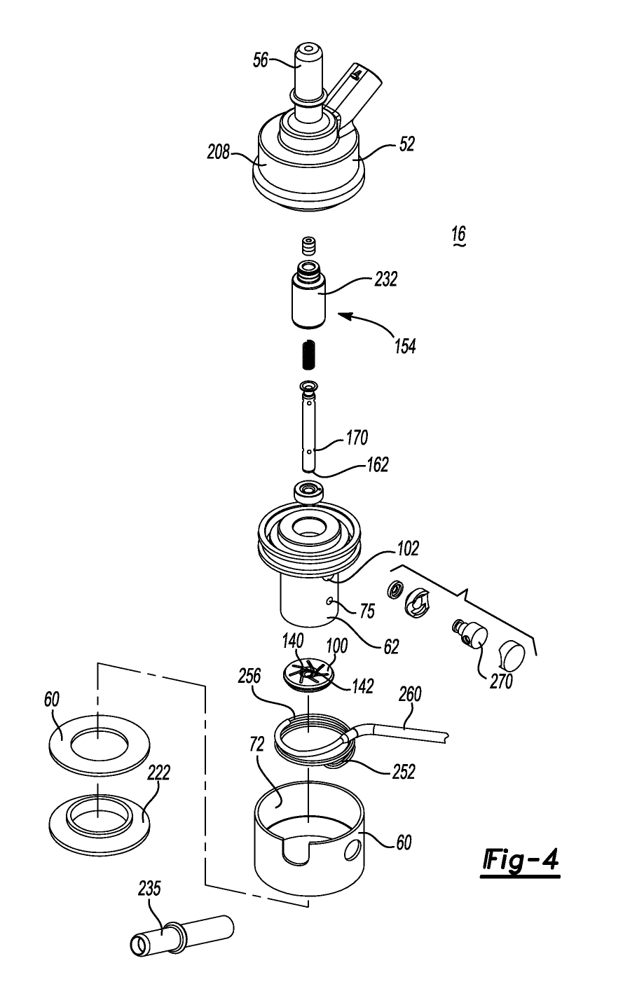

With reference to FIGS. 2-5, reagent injector 16 includes a cartridge body assembly 50, an outer electromagnetic assembly 52, a mounting plate 54, an inlet assembly 56, and an outer assembly 58. The cartridge body assembly 50 includes a tubular outer body 60 fixed to a tubular inner body 62. The outer body 60 includes a first end 64 and an opposite second end 66.

The outer body 60 includes an inner surface 72 defining a substantially cylindrical bore 76 having a reduced diameter portion 75. The outer body also includes an enlarged diameter portion 74. Inner body 62 is a substantially hollow tube having a bore 78 defined therethrough. The bore 78 includes a first reduced diameter portion 80 and a second enlarged diameter portion 82.

The inner body 62 is fixed to the outer body 60 using a laser or brazing process. The fixation of the inner body 62 to the outer body 60 defines a lower chamber 90. A portion of the lower chamber 90 defines a capillary tube supply passage 86 which, as described below, encloses and protects a capillary tube reagent supply.

Cartridge assembly 50 can also include a lower guide 96, and slotted orifice plate 100. Lower guide 96 includes a substantially cylindrical outer surface sized to fit within the reduced diameter portion 75 of outer body 60. A bore 104 extends through the lower guide 96 to allow cooling fluid to pass therethrough.

Orifice plate 100 includes an orifice 140 coaxially aligned with a conical valve seat 142. When utilized, the cylindrical portions 136 of swirl slots 132 define a circle flow path that is coaxially adjacent the orifice 140 and conical valve seat 142. Orifice plate 100 includes an outer cylindrical surface 148 that is sized to closely fit with reduced diameter portion 79 of inner body 62. The orifice plate 100 is welded into place as described above.

A pintle 156 is slidably positioned within the enlarged diameter portion 82 of bore 78. Pintle 156 includes a conically shaped first end 158 and an opposite second end 160. First end 158 is selectively engageable with valve seat 142 of orifice plate 100 to define a sealed and closed position of pintle 156 when seated. The second end 160 defines an aperture 246 coupled to a central bore 184 defined in the elongated pintle 156. An unsealed, open position exists when pintle 156 is spaced apart from valve seat 142. Valve seat 142 may be conically or cone-shaped as shown to complement the conical first end 158 of pintle 156 to restrict the flow of reagent through orifice 140. Depending on the application and operating environment, pintle 156 and orifice plate 100 may be made from a metallic, ceramic or carbide material, which may provide desired performance characteristics and may be more easily and cost-effectively manufactured. Orifice plate 100 may alternatively be constructed from a precipitation hardened material, CPM S90V or 440C stainless steel.

Pintle head 162 is slidably positioned within bore 78 and is coupled to pintle 156 which includes a plurality of circumferentially spaced apart first apertures 170 and a plurality to second apertures 171 extending therethrough. The pintle head 162 can define an aperture 173 which allows the flow of fluid therethrough upon application of the valve. A running-class slip fit between pintle 156 and inner surface 70 provides an upper guide for pintle valve 156 to translate along an injection axis 155.

Electromagnet assembly 52 includes a coil of wire 200 wrapped around a bobbin 202. Pintle head 162 is constructed from a magnetic material such as 430 stainless steel such that electrical energization of coil 200 produces a magnetic field urging pintle head 162 and joined pintle 156 in a first direction away from the valve seat 142. When coil 200 is energized, first end 158 of pintle 156 becomes disengaged from valve seat 142 to allow reagent to flow through orifice 140.

Power may be provided to coil 200 via access to a receptacle 206 of an overmolded housing 208, for example, in response to a signal from electronic injection controller 14. The overmolded housing 208 can be coupled to the inner body 62 through the slot 209 defined in inner body 62.

A flux frame 210 includes a tube 212 surrounding bobbin 202 and coil 200. An end cap 214 extends from tube 212 to an outer surface of outer body 60. Cartridge assembly 50 extends through electromagnet assembly 52 as well as mounting plate 54. Outer body 60 is laser welded to mounting plate 54 proximate a mounting plane 222 of mounting plate 54 as well as at a location proximate pintle head 162. The laser welds extend uninterruptedly 360 degrees to form a seal between mounting plate 54 and outer body 60. No additional elastomeric seals are required.

Inlet assembly 56 includes a 300 series stainless steel inlet tube 236 and an inlet filter 232. Inlet tube 236 includes a first end 240 sized to be received within a pocket 242 formed in overmolded housing 208. Inlet tube 236 is laser welded to inner body 62 to retain electromagnet assembly 52 between outlet assembly 58 and mounting plate 54. Inlet tube 236 is in fluid communication with central bore 184 of elongated pintle 156.

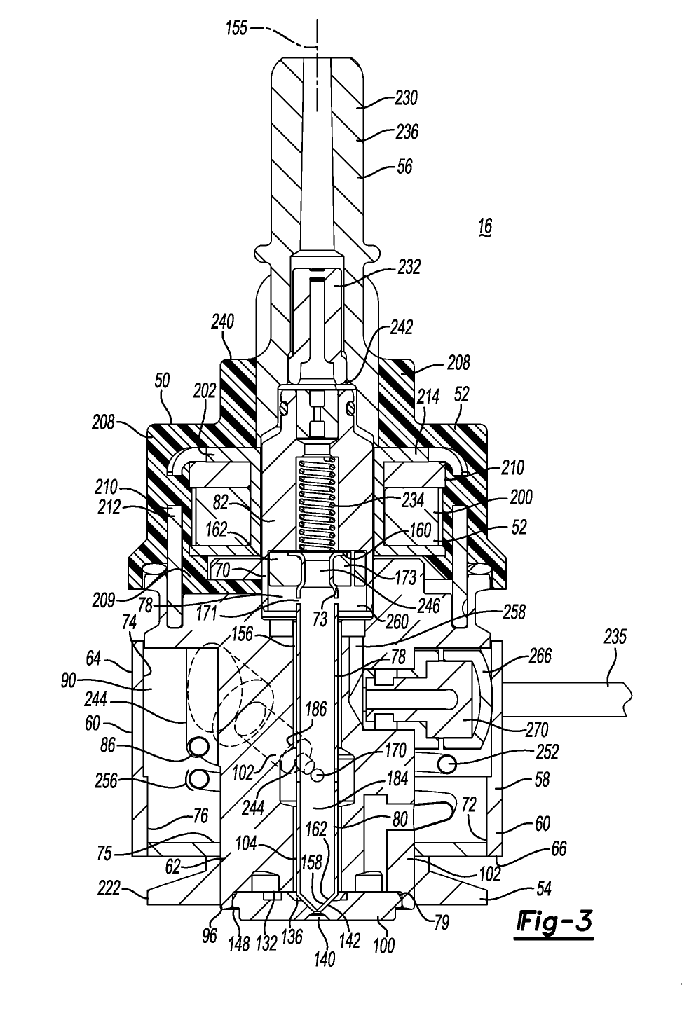

As best seen in FIGS. 3-5, the flow of the reagent is split into two distinct pathways upon entering the valve assembly. The first path or cooling path allow reagent to circulate through the valve to cool it during normal operation of the vehicle. In this regard, when reagent is not needed within the exhaust system, the pintle 156 remains seated and cooling liquid reagent is circulated though the valve to protect the valve components. The second reagent path is through a splitting manifold 260 and into one or more capillary tubes 252. The capillary tubes 252 function to maintain the reagent in a liquid phase at temperatures and pressures found within the valve when the valve is closed. The capillary tube 252 further converts the liquid phase to gas when the valve is in an open condition. Liquid reagent is pumped through the capillary tubes 252 and is converted to a vapor upon leaving the capillary tubes 252. The vapor reagent then transfers past the valve seat 142, and supplies vapor or atomized reagent into the exhaust system 18.

In the first path 274, a closed loop reagent fluid path is provided when pintle 156 of reagent injector 16 is in the closed position. Reagent is provided from tank 10 via delivery module 12 to inlet tube 230. In a cooling loop or circuit 254, reagent passes through inlet filter 232, inlet passageway 234 and manifold 260 to enter central bore 184. As reagent continues to flow through apertures 170 and enters a return aperture or bore 244 of inner body 62 it removes heat. Pressurized reagent continues to flow through apertures 170 of pintle 156 and central bore 184 of elongated pintle 156 until the temperature reaches an appropriate level or the pintle 156 is opened. Restrictor portion 186 includes an aperture 244 through which the return flow rate of reagent can be controlled. Outlet tube 235 is coupled to the aperture 244 and is in receipt of the reagent returning to tank 10. When reagent is not being injected into the exhaust system, the reagent is continuously pumped to flow through lower chamber 90 and transfers heat from orifice plate 100 and to, for example, the reagent stored in tank 10.

When electromagnet assembly 52 is energized, pintle 156 is moved from valve seat 142. Pressurized reagent flows through the manifold 260 and into the capillary coupling member 270. From the capillary coupling member 270, the reagent flows through the second path 276 as a liquid through the capillary tube 252. Upon exiting the capillary tubes 252, the liquid changes phase from liquid to vapor and flows through each of swirl slots 132 to enter circular portions 136 of the orifice plate 100. Based on the pressure differential between orifice 140 and swirl slots 132, as well as the tangential relationship of swirl slots 132, a rapidly moving circular reagent motion is induced. The lower pressure at orifice 140, combined with the pressurized reagent moving in a capillary tube, creates a finely atomized spray exiting orifice 140. Upon closing the valve, reagent that does flow through the second path does not exit orifice 140 and continues to be recirculated. Flow through the pintle 156 can be restricted by a member 73, thus allowing flow only through the capillary tube 252 when the pintle 156 is disengaged from the orifice 140.

Optionally, the capillary tube or tubes 252 can include a heating element 256 which can heat the reagent during startup of the vehicle. As can be appreciated, the liquid reagent converts to an ambient pressure vapor when leaving the capillary tube 252. The heating element 256 has a power control which uses pulse width modulation to keep the capillary tube 252 at a desired temperature. The closed loop control uses the momentary resistance values of the capillary heating elements 256 as a measure of temperature, which is also a measure of the liquid temperature. It is envisioned the frequency of the pulse width modulation is up to several hundred Hz. The operating pressure for the capillaries can be between about 50 and 80 psi with operating temperatures from about 300 to about 400° C.

When oxidation of hydrocarbons is needed, the capillary tube 252 elevates the temperature of the reagent to a temperature where the reagent is a fluid within the capillary tube 252 and atomized when the fluid leaves the tube at atmospheric pressure. This prevents the clogging of the capillary tube 252 as the reagent sits in the capillary tube in a liquid phase. Once the reagent has changed phase from liquid to gas, the reagent moves away from the capillary tube 252 to the optional swirl slots 132 and out through orifice 140. The liquid reagent first travels along the capillary tube 252 until reaching valve seat 142. Optionally, movement of the pintle can restrict movement of the liquid reagent along conduit 258 from the manifold 260 to the first capillary tube 252. In so doing, the valve causes the liquid reagent to flow into cooling circuit 254 and away from the capillary tube 252. Upon activation of the pintle, the reagent can selectively be fed to the capillary tube 252 if the valve member 154 is in an open state allowing the flow there through.

When partially oxidized hydrocarbons are needed, the valve pintle head 162 is toggled into the open state to allow reagent to encounter capillary tube 252 when exhaust system ambient conditions are low (i.e., when more heat is required by the exhaust control system). When exhaust control system ambient conditions are at low temperature such as at vehicle startup, more reagent enters the exhaust system, as reagent is permitted to flow through both capillary tubes 252. Allowing flow through capillary tube 252 decreases resistance to flow and, therefore, decreases the pressure of the reagent allowing conversion to vapor.

When exhaust system ambient conditions are a hot temperature, the solenoid valve 154 is closed, directing all reagents through cooling circuit 254 and optionally bypassing capillary tube 252. As flow through the capillary tube 252 is prevented the pressure of the reagent in the capillary tube increases, therefore decreasing the tendency of the reagent to change phase to a vapor phase.

When exhaust system 18 ambient conditions are low, reagent is directed through capillary tube 252 and into the exhaust system 18. The capillary tube 252 outputs are disposed proximate to inlet 264 of the exhaust system 18. Upon leaving capillary tube 252, the reagent expands and vaporizes prior to the reagent entering the exhaust system 18. The reagent in one embodiment can be diesel fuel, where the diesel fuel in the capillary tube is maintained at an operating range between 5° C. and 95° C. while the value is in a seated position.

The reagent exiting capillary tube 252 is preferably expanded prior to entering the exhaust system 18. Once in the exhaust system 18, the reagent encounters and heats the catalyst bed 17 as previously described. The reagent exiting capillary tube 252 is expanded and is piped directly into an inlet of the exhaust system 18. When the pintle valve is closed, the reagent bypasses the capillary tubes 252 and circulates through the cooling circuit 254.

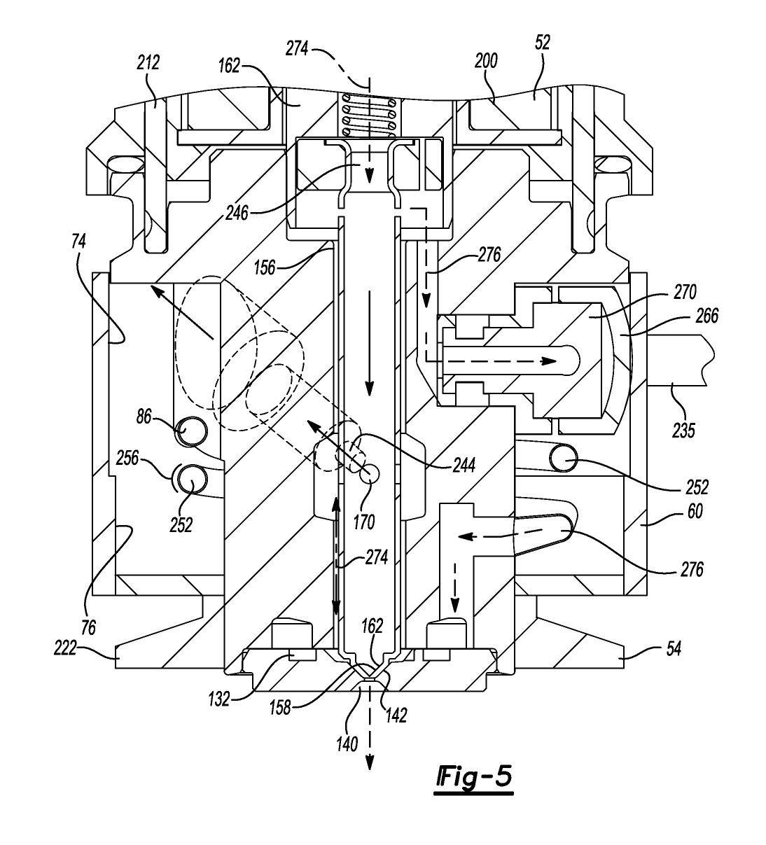

As shown in FIG. 5, the vapor injection system can operate in either two or three modes of operation. First, when exhaust ambient conditions are low (i.e., when less heat is therefore required for pollution management), solenoid valve 154 may be toggled into the open state to allow reagent to encounter capillary tube 252. When reagent is permitted to encounter capillary tube 252, reagent flows through fluid inlet 266 to the capillary tube 252 and into coupling 270 prior to reaching the valve seat orifice 140. By allowing reagent to flow through and leave the capillary tubes 252, the pressure of the reagent is decreased and a greater volume of reagent reaches the exhaust flow. Disengagement of the pintle 156 decreases the pressure within the lower chamber 90, allowing reagent to flow through the capillary tube 252. Upon exiting the capillary tube 252, the reagent is converted to a vapor and passed through the orifice plate 100 and into the exhaust system 18. In this regard, the reagent can be heated to the point where it is converted to an atomized gas phase at atmospheric pressure. In situations where the system injects reductant reagents, injection could be continuous. In this situation, the injectors and capillaries would be powered continuously during engine operation. Power to the capillary heating element 256 could be subject to the previously mentioned pulse width modulation heat control regime.

Second, when exhaust system ambient conditions are high (i.e., when less heat is required by the exhaust system), solenoid valve 154 may be toggled into the closed state to restrict reagent from leaving the orifice 140. Optionally, the aperture 173 can be positioned to block or restrict the flow of reagent through the capillary tubes 252 in preference of the cooling circuit 254 when the pintle head 162 is seated. By restricting reagent from flowing through capillary tube 252, the pressure of the reagent is increase thus keeping the reagent a liquid phase. Therefore, controlling the solenoid valve 154 between the open and closed states provides the vapor injection system with the ability to adjust to fluctuating outdoor ambient conditions.

Third, for applications where an exotherm is formed within the exhaust system, the heated capillary control activated independently but simultaneously at lower exhaust temperature levels. When the temperature of the exhaust system reaches about 400° C., the power to the capillaries heating elements 256 can be turned off. At this point, the pintle can be moved to a location where optionally the pintle 156 can function as a normal injector, atomizing the discharge liquid without vaporizing it through the capillary tube 252. Reagents injected into the exhaust system will be vaporized through exhaust gas heating after discharge and atomization. Optionally, fluid can flow adjacent to the first end 158 of the pintle 156 and past the valve seat 142 of orifice plate 100 as well as through the capillary tube 252.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An injector for injecting a liquid hydrocarbon into an exhaust system, comprising:
a housing defining an exit orifice and having an inlet tube and a return tube, the inlet tube being adapted to receive liquid hydrocarbon from a source of reagent, the return tube being adapted to return hydrocarbon to the source of reagent;
an axially translatable valve member positioned within the housing;
an electromagnet positioned within the housing and including a coil of wire positioned proximate the valve member, wherein the valve member moves between a seated position and an unseated position relative to the orifice in response to energizing the electromagnet; and
a capillary tube disposed between the inlet tube and the orifice.

2. The injector of claim 1, wherein the capillary tube includes a heating element.

3. The injector of claim 2, wherein the capillary tube is positioned inside of the housing.

4. The injector of claim 3, wherein the liquid hydrocarbon is diesel fuel.

5. The injector of claim 4, wherein the liquid hydrocarbon converts to an ambient pressure vapor.

6. The injector of claim 1, wherein the liquid hydrocarbon simultaneously flows in a first direction through the inlet tube and in a second opposite direction through the return tube when the valve member is in the seated position.

7. The injector of claim 6, further including a lower body positioned in the housing, the lower body including a plurality of capillary tubes in fluid communication with the inlet tube.

8. The injector of claim 7, wherein at least one of the plurality of capillary tubes comprises a heater.

9. An injector for injecting a liquid reagent, comprising:
a housing defining an output orifice;
an axially translatable valve member positioned within the housing;
an electromagnet positioned within the housing such that the valve member moves between a seated position and an unseated position relative to the output orifice in response to energizing the electromagnet;
an inlet tube adapted to receive pressurized reagent from a source of reagent;
a return tube being adapted to return reagent to the source of reagent;
an inner body positioned within the housing, the inner body and housing at least partially defining a flow path for reagent to pass therebetween; and
having a capillary tube fluidly coupled to the inlet tube, wherein the reagent flows from the inlet tube, through the flow path to the return tube when the valve member is in the seated position, and the reagent flows from the inlet tube, through the capillary tube, and out of the output orifice when the valve member is in the unseated position.

10. The injector of claim 9, wherein the capillary tube elevates the temperature of the reagent to a temperature where the reagent is a fluid within the capillary tube and atomized when the liquid reagent leaves the capillary tube at atmospheric pressure.

11. The injector of claim 9, wherein the housing includes a plurality of heated capillary tubes to selectively direct reagent from the inlet tube to the orifice.

12. The injector of claim 11, wherein the liquid reagent is atomized when exposed to atmospheric pressure and the valve member is in the unseated position.

13. The injector of claim 9, wherein the reagent flows from the inlet tube through the flow path and subsequently enter the return tube to cool a portion of the valve.

14. The injector of claim 9, further defining a manifold positioned in the housing, the manifold fluidly connecting the capillary tube, the axially translatable valve and the return tube.

15. An injector for injecting a liquid reagent into an exhaust system. the injector comprising:
a housing defining an inlet tube, a return tube and an exit orifice;
an axially translatable valve member positioned within the housing;
an electromagnet positioned within the housing such that the valve member moves between a seated position and an unseated position relative to the orifice in response to energizing the electromagnet; and
a body positioned within the housing, the body at least partially defining a flow path for reagent to pass therethrough, the body including a return passage and a capillary tube, wherein the reagent flows from the inlet tube, through the flow path and the return passage to the return tube when the valve member is in the seated position, and the reagent flows from the inlet tube, through the capillary tube, and out of the orifice when the valve member is in the unseated position.

16. The injector of claim 15, wherein the capillary tube maintains the reagent in a liquid phase.

17. The injector of claim 16, wherein the reagent is atomized when the reagent leaves the capillary tube.

18. The injector of claim 15, wherein the capillary tube is heated.

19. The injector of claim 15, wherein the temperature of the capillary tube is maintained using a pulse width modulation controller.

20. The injector of claim 15, further comprising a plurality of heated capillary tubes, each tube connected at a first end to the inlet tube and fluidly connected to the orifice at a second end.

21. The injector of claim 15, wherein the reagent comprises diesel fuel and wherein the reagent in the capillary tube is maintained at a temperature between 5° C. and 95° C. while the value member is in the seated position.
